(19) United States
(12) Patent Application Publication
(10) Pub. No.: US 2009/0032523 A1
(43) Pub. Date: Feb. 5, 2009

(54) Conformable heating pad

(76) Inventor: Jill Youngblood, Boynton Beach, FL (US)

Correspondence Address: Sunbeam Products, Inc., 2381 Executive Center Drive, Boca Raton, FL, 33431, US

(21) Appl. No.: 11/888,117

(22) Filed: Jul. 31, 2007

(51) Int. Cl. H05B 3/34

(52) U.S. Cl. 219/528

(57) ABSTRACT

A conforming heating pad having a curvilinear Y-shaped recess has a pair of opposed curved wing sections surrounding a centralized opening occupied by a central flap portion created by the Y-shaped recess. A pair-of opposed multi-layer constructions housing a resistive NTC sensing wire and a plurality of individual weights serve to enhance the conformity of the heating pad. The heating pad is operable in at least two modes, including a constant heating level mode at various user-selectable temperature levels and a timed mode that offers user-selectable temperature levels over a user-selectable period of time. The heating pad can be wetted to offer a moist heat therapy.

### FIELD OF THE INVENTION

The present disclosure is related generally to electrically heated pads. In particular, the present disclosure is directed to a conformable heating pad optimized to better conform to the varying contours of the human body and to provide either a consistent or a cycled level of heat.

### BACKGROUND OF THE INVENTION

The statements of this section merely provide background information related to the present disclosure and may not constitute prior art.

Medical research has shown that heat therapy over an extended period of time can provide significant benefits for patients experiencing muscle and soft tissue cramping, pulls or strains. It is well understood that heat therapy provides several benefits for simple injuries, including the stimulation of the sensory receptors in the skin thus causing the heat to serve as an analgesic (i.e., reducing the transmission of pain signals to the brain), a relaxation of the soft tissues and a reduction of joint stiffness in the area of the treatment, and the vasodilation of the blood vessels in the treated area.

Vasodilation is a physical response to a localized increase in temperature. The response has several distinct parts. The first three to five minutes of the reaction are generally attributed to a nervous system reaction which is characterized by the relaxation of the muscle tissue immediately surrounding the local blood vessels thus allowing the vessels to expand and is further characterized by a significant increase in blood flow to the treated area. After this initial nervous system response, blood flow decreases moderately for a short period of time and is immediately followed by a gradual increase in blood flow until a sustained higher than normal level of blood flow to the area is reached after approximately 25-30 minutes of treatment. Clinical studies have determined that the ideal temperature to achieve full vasodilation is approximately 108° F., but must be at least 102° F. in order to obtain any benefits from an extended heat therapy.

While such heat treatment can enhance healing, it has been known that a moist heat will penetrate the body's tissues deeper than the dry heat generally provided by the common heating pad. Further, in order to optimize a heat treatment, the thermal transfer between the heating pad and the user must be maximized. Generally, common heating pads are limited to basic square or rectangular shapes that do not readily conform to the complex geometry of the human body, and in particular do not readily conform to various joints (i.e., shoulders, elbows, knees, neck, lap, etc.) which are often the locations requiring such treatment. Further, commonly available electrically heated pads are generally not well suited for delivery of moist heat.

### BRIEF SUMMARY OF THE INVENTION

A conformable heating pad is specifically shaped and suited for use on the complex geometries of the human body. In particular, a weighted heating pad is shaped to enhance the conformity with the region of the body with which it is engaged and thus enhancing the heat transfer between the pad and the user's body. Further, the present invention allows for the introduction of moisture to the product for the generation of an increased area of humidity between the pad and the user's body thus resulting in an improved heat transfer and therapeutic treatment.

The heating pad may include a multi-layer construction of successive layers of electrically non-conductive materials separated by a non-woven batting. Two of such opposed multi-layer constructions may be sandwiched about a resistive heating element. The element may be located in grooves formed in the inner layer of one of the constructions. A plurality of individual weights may be affixed to the inner layer of the same or the opposing construction. The predetermined pattern of the heating element may be such that the individual weights are located between the various loops in the element further assuring a uniform thermal distribution across the pad.

The heating pad may operate in two primary modes—a consistent heat mode and a timed mode. As designated by the user, the heating pad may be capable of providing a consistent level of heat based upon the selected setting of a separable controller or may provide a heat treatment at a user-defined heat level for a user-selected period of time. It should be noted that both modes are operable regardless of whether a user chooses to use the pad to supply a dry heat or through the introduction of moisture to the pad surface to supply moist heat to the treatment area.

### BRIEF DESCRIPTION OF THE DRAWINGS

A more complete appreciation and many of the attendant advantages of the heating pad will be readily obtained as the same becomes better understood by reference to the following detailed description when considered in connection with the accompanying drawings, wherein similar reference numbers refer to similar elements.

FIG. 1 shows an overhead view of an embodiment of a heating pad;

FIG. 2 shows an exploded view of a heating pad construction;

FIG. 3 shows one exemplary pattern for both the heating element and the plurality of individual weights used in a heating pad;

FIG. 4A shows an exemplary heating pad in use on the lap of a user;

FIG. 4B shows the exemplary heating pad of FIG. 4A in use on the lower back of a user;

FIG. 4C shows the exemplary heating pad of FIGS. 4A and 4B in use on the knee of a user; and

FIG. 4D shows the exemplary heating pad of FIGS. 4A, 4B, and 4C in use on the shoulder of a user.

### DETAILED DESCRIPTION OF THE EMBODIMENTS

While the heating pad may be susceptible to embodiment in different forms, herein will be described in detail, embodiments with the understanding that the present description is to be considered an exemplification of the principles of the invention and is not intended to limit the scope of the appended claims to that as illustrated and described herein. Instead, it is envisioned that those skilled in the art may devise various modifications and equivalents without departing from the spirit and scope of the appended claims.

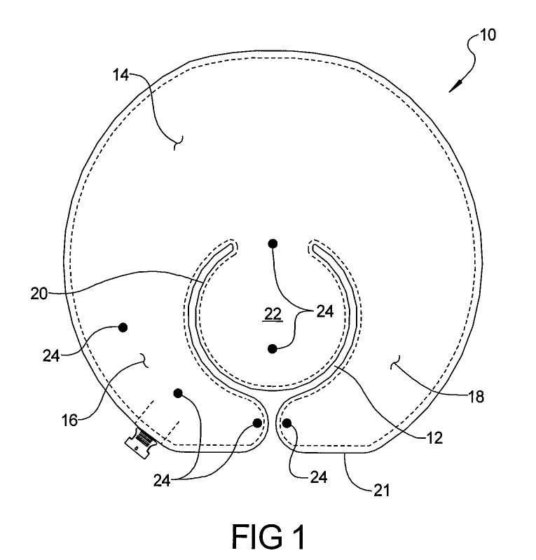

A weighted therapeutic heating pad 10 as seen in FIG. 1 includes a generally circular shaped pad having a curvilinear Y-shaped slot 12 therein. The Y-shaped slot 12 divides the pad 10 into a main body portion 14, a first curved wing section 16, a second curved wing section 18 opposite the first wing section 16, a central opening 20 situated between the main body portion 14 and the curved wing sections 16 and 18, and a flap portion 22 located within the central opening 20. As part of the enhanced flexibility of the pad 10 there is provided a plurality of securing means 24 about a surface of the pad 10, such as at free end portion 21, to allow for overlap of the curved wing sections 16 and 18 and to allow for securing the flap portion 22 to the main body 14 leaving the vacant central opening 20. The securing means 24 can be snaps, buttons, clasps, hook and loop fabric, and any other releasable fasteners.

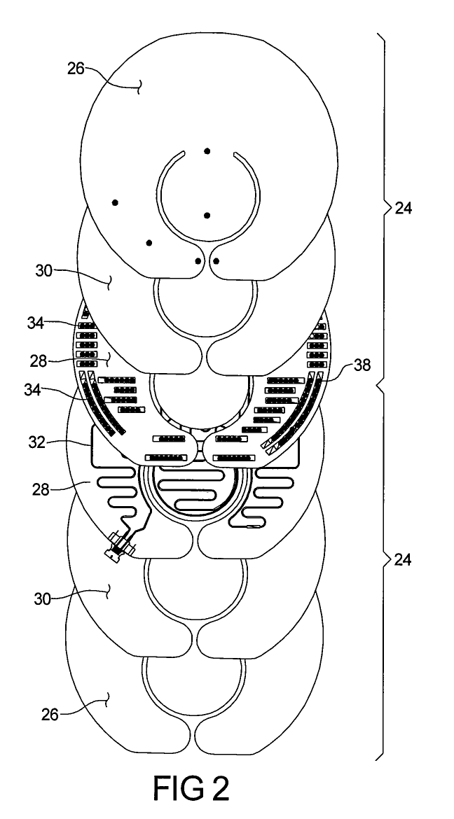

FIG. 2 shows an exploded view of a therapeutic heating pad 10 including a pair of opposed multi-layer constructions 24. Each multi-layer construction 24 includes an outer shell 26 and a scrim 28 separated by a layer of a batting material 30. The batting material 30 is included to both enhance the comfort of the pad 10 during its use, as well as to provide an air-insulation layer within the constructions 24. The opposed constructions 24 are layered or sandwiched around a resistive heating element 32 and a plurality of individual weights 34. The individual weights 34 can be formed of ceramic pellets. Further, to provide adequate weight to enhance the conformability of the pad 10, it is preferred that the weight of all of the individual weights 34 total between generally about one and three pounds, more preferably two pounds.

Without some mechanism for retaining the heating element 32 in its designated pattern between the scrims 28, any physical manipulation of the heating pad 10 could result in its displacement. Such displacement could result in a crimping of the heating element 32 or significantly reduce the effectiveness of the pad 10 by reducing the uniform thermal distribution inherent in the heating element 32 layout. In order to secure the heating element 32 in place, it is preferred that the at least two opposed scrims 28 are secured to each other in such a manner as to produce retaining channels 36 through which the various loops of the heating element 32 are run as it traverses its path within the heating pad 10. Individual pockets 38 of varying numbers of the individual weights 34 are also preferably located between the loops of the heating element 32 throughout the heating pad 10. The individual weights 34 can be loose individual weights or packets, pouches, or flexible tubes of a desired number of weights so as to keep the weights together and make manufacturing of the heating pad easier. Additionally, the outer periphery of all the various layers with the two opposed constructions 24 are secured together to complete the manufacture of the heating pad 10.

The outer shells 26 and the scrims 28 include an electrically non-conductive, heat-resistive sheet material. Such material is preferably a polymer, such as polyester, polyvinyl chloride, or polypropylene.

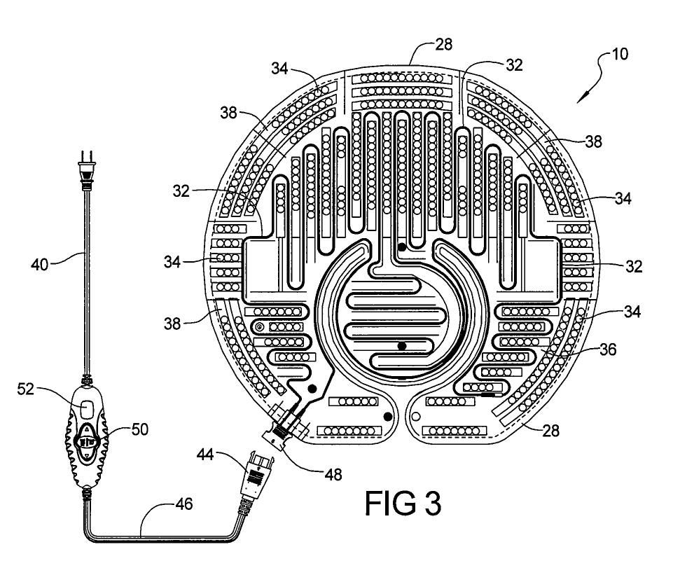

In an effort to enhance the safety of the device during operation, and as best seen in FIG. 3, the heating element 32 of the present invention can be formed of positive or negative temperature coefficient wire capable of sensing temperature differentials along its length such that it serves as a plurality of discrete sensors capable of detecting localized hot spots. Operation of such wires is well known in the art and is discussed in greater detail in U.S. Pat. No. 7,180,037, issued to Weiss on Feb. 20, 2007, and which is fully incorporated herein by reference.

The heating pad additionally includes a cord set 40, 42, and 44, and a controller 46. Cord 40 is for connection to a power supply (not shown), including but not limited to a 110V or 220V wall outlet and is secured at the opposite end to controller 46 for delivery of electrical power thereto. Cord 42 is secured at one end to controller 46 and has a releasable connector 44 at the opposite end. Connector 44 may be one of any known type of releasable electrical connections, including, a snap-lock connector 44 that corresponds to a receptacle 48 extending from the periphery of pad 10 and into which the ends of the looped heating element 32 are secured.

Controller 46 includes a microprocessor and its internal clock (not shown) which function to vary the electrical draw required to increase or decrease the thermal output of the resistive heating element 32 in accordance with a user-selected setting, as well as serving to limit the operation of the pad 10 during its timed mode of operation. The controller 46 further includes an activator 50 to control all of the functions of the pad 10 through the manipulation of one or more switches.

The activator 50 may include any of the many known types of rotary or switch type devices suitable for operating a multi-setting electrical appliance. Controller 46 can include a four position “jog”-type switch 50. One setting of the switch 50 is indicated as “OFF”. When in this position jog switch 50 prevents electricity flow to the pad 10 via cord 42 and connector 44. Transition of the jog switch 50 into any other position will automatically activate the pad 10. In a second and third position, the jog switch 50 serves to allow the user to transition “UP” or “DOWN” through the multiple user-selectable heat settings. The jog switch 50 may be used to activate the timed mode of operation of the pad 10 by moving the switch 50 to the “STAY ON” setting. When this mode is activated, the switch 50 settings corresponding to “UP” and “DOWN” serve to transition the user through the multiple user-selectable time periods available for set periods of activation of the pad 10 until such time that the period of activity has been chosen and then they will revert back to allowing the user to transition through the available temperature settings.

In operation, the pad 10 is capable of operating in three different modes. First, the pad 10 can be activated to offer a consistent level of heat based on a user-selected setting from those available. The controller 46 preferably includes a digital display 52 capable of showing the presently selected temperature level and/or the available time durations during operation of the pad 10 in the timed mode.

Second, the pad 10 can be activated to offer a timed mode. During operation of the pad 10 in the timed mode, the pad will be active for only a user-selected period of time before being automatically turned off, however, the user is still able to set or alter the temperature level provided by the pad 10 during such given period of time using the controller 46 as discussed above.

Third, the pad 10 may be operated in either of the first or second mode such that the pad 10 provides the user a moist heat. In this mode of operation, no alternative switch settings are required beyond that discussed above. Instead, the pad 10 is can be constructed of materials that allow for the heating pad to be submerged in or exposed to water so as to moisten or soak the pad 10. After such treatment, the retained moisture in the various layers of the pad 10 adds humidity to the heat treatment making it a moist heat therapeutic treatment.

To enhance the therapeutic capability of the pad 10, it is preferred that the controller 46 provide at least eight user-selectable temperatures, including a “HIGH” and a “LOW” setting and six settings in-between. The temperature range across all of the available settings ranges from generally about 85° F. on the “LOW” setting to generally about 165° F. on the “HIGH” setting. Further, it is preferred that the available user-selectable time periods for the timed mode of operation range from one-half hour to at least four hours in half hour increments.

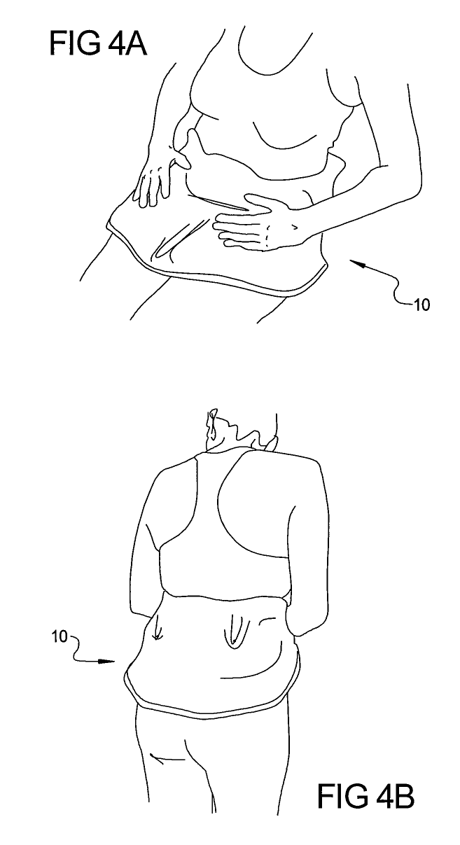

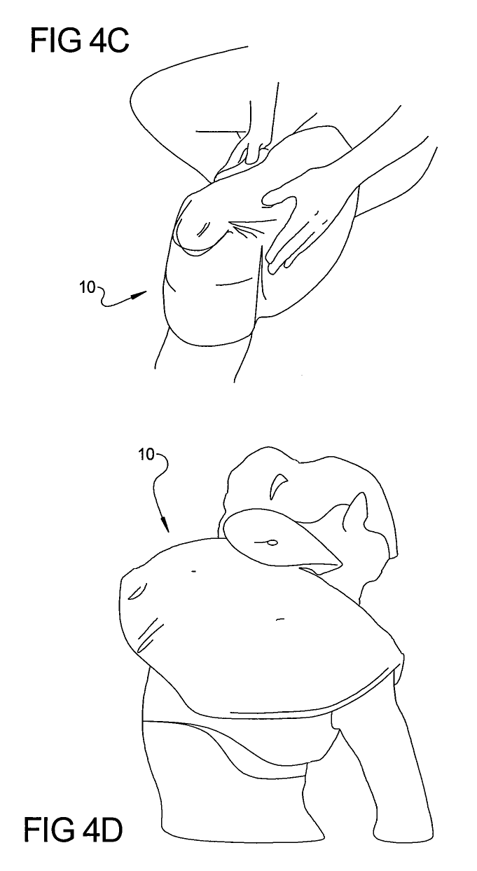

As best seen in FIGS. 4A-D, the curved wing sections 16 and 18 and the central flap portion 22 work in coordination with the main body 14 to wrap around the three dimensional curved shapes associated with the joints and other portions of the human body most often requiring heat-based therapy. As discussed above, in order to further aid the weighted pad 10, there are provided a plurality of securing means 24 about an upper surface of the heating pad 10 to allow overlapping of the curved wing sections 16 and 18 and/or for securing the central flap portion 22 to the main body 14 so as to expose the central opening 20. With the wing portions 16 and 18 secured together and the central opening 20 exposed, appendages, such as an arm, leg or head can be passed through the central opening 20 so as to allow for additional application of the heating pad 10 to areas of the body including the back of the thighs, the ribs, or the upper back without requiring the user to hold the pad 10 in place.

Those skilled in the art can now appreciate from the foregoing description that the broad teachings of the disclosure can be implemented in a variety of forms. Therefore, while this disclosure-includes particular examples, the true scope of the disclosure should not be so limited since other modifications will become apparent to the skilled practitioner upon a study of the disclosure.

What is claimed is:

1) An electrically heated pad, comprising:
a pair of opposed multi-layer constructions;
a serpentine heating element, wherein the opposed constructions surround the heating element; and
a plurality of individual weights encased between the opposed constructions.

2) The electrically heated pad of claim 1, wherein each of the opposed multi-layer constructions comprises:
an outer layer;
an inner batting layer; and
a scrim, wherein all of the layers are secured together about their outer periphery.

3) The electrically heated pad of claim 2, wherein the outer layer is comprised of one of a material from the group consisting of polyester, polyvinyl chloride, and polypropylene.

4) The electrically heated pad of claim 2 wherein the scrim is comprised of one of a material from the group consisting of polyester, polyvinyl chloride, and polypropylene.

5) The electrically heated pad of claim 2 wherein the batting layer comprises a non-woven material.

6) The electrically heated pad of claim 1, wherein the plurality of individual weights comprises individual ceramic pellets.

7) The electrically heated pad of claim 6, wherein weight of the plurality of individual weights total from one to three pounds.

8) The electrically heated pad of claim 1 wherein said heating element is comprised of a negative temperature coefficient sensing wire.

9) The electrically heated pad of claim 2, further comprising a plurality of securing means suitable for releasably altering the configuration of the pad.

10) An electrically heated pad comprising:
a generally circular main body having a curvilinear recess dividing the main body into a pair of opposed curved wing sections and a central flap portion;
wherein the heated pad further includes a plurality of individual weights secured within the pad.

11) The electrically heated pad of claim 10, further comprising an encased serpentine heating element.

12) The electrically heated pad of claim 11, wherein the plurality of individual weights are secured between the curved portions of the serpentine heating element and wherein the curvilinear recess is “Y”-shaped.

13) The electrically heated pad of claim 10, wherein the pad is operable both wet and dry.

14) The electrically heated pad of claim 13, wherein the pad is operable in at least two different modes, a first consistent heat level mode in which a user can select a heating level at which the pad will operate and a second timed operation mode in which a user can select a period of time over which the pad will provide heat at a user-selected heating level.

15) An electrically heated pad, comprising:
a generally circular main body having a configurable shape including a centrally located flap portion that can be secured to the main body to expose a central opening, wherein the opening is suited for passage of a body part there through;
a heating element secured within the main body;
a plurality of individual weights located within the main body; and
wherein the main body is comprised of a material from the group consisting of polyester, polyvinyl chloride, and polypropylene.

16) The electrically heated pad of claim 15, wherein the main body comprises:
a pair of opposed multi-layer constructions including an outer layer, an inner batting layer, and a scrim, wherein all of the layers are secured together about their outer periphery.

17) The electrically heated pad of claim 15, wherein the serpentine heating element is a negative temperature coefficient sensing wire.

18) The electrically heated pad of claim 15, wherein the plurality of individual weights comprises individual ceramic pellets.

19) The electrically heated pad of claim 15, wherein the weight of the plurality of individual weights total from one to three pounds.

20) The electrically heated pad of claim 15, wherein the pad is operable both wet and dry.
